(19) United States
(12) Patent Application Publication
(10) Pub. No.: US 2010/0098584 A1
(43) Pub. Date: Apr. 22, 2010

(54) CLINICAL ANALYSIS APPARATUS

(75) Inventors: Kazuhisa Kobayashi, Minamiashigara-shi (JP); Yoshihiro Seto, Ashigarakami-gun (JP); Masayoshi Hayashi, Amagasaki-shi (JP); Tatsuo Kurosawa, Amagasaki-shi (JP); Tomohisa Kawabata, Mountain View, CA (US)

Correspondence Address: SUGHRUE MION, PLLC, 2100 PENNSYLVANIA AVENUE, N.W., SUITE 800, WASHINGTON, DC, 20037, US

(73) Assignees: FUJIFILM Corporation, Tokyo (JP); Wako Pure Chemical Industries, Ltd., Amagasaki-shi (JP)

(21) Appl. No.: 12/579,644

(22) Filed: Oct. 15, 2009

Related U.S. Application Data
(63) Continuation-in-part of application No. 12/593,875, filed on Sep. 29, 2009.
(60) Provisional application No. 60/920,815, filed on Mar. 30, 2007.

(51) Int. Cl. G01N 35/00; G01N 27/26; G01N 35/10; G01N 35/04; G01N 35/02; G01N 1/28

(52) U.S. Cl. 422/64; 422/63; 422/65

(57) ABSTRACT

[Objective]

To control the temperatures of reagents and samples in a clinical analysis apparatus, without causing the apparatus to become large or complex.

[Constitution]

A clinical analysis apparatus is equipped with a measuring section. The measuring section includes: a dispensing station, at which reagents and samples are dispensed into microchips having micro flow channels formed therein; a detecting station, for detecting measurement target substances included in the samples; and the like. The microchips are continuously rotated relative to the dispensing station, the detecting section, and the like from the upstream side to the downstream side of processes to be administered, to perform measurement repeatedly. A temperature controlling section controls the temperatures of the microchips prior to the microchips being moved to the detecting station, and the measurement target substances included in the samples which are dispensed into the microchips are measured.

### TECHNICAL FIELD

The present invention relates to a clinical analysis apparatus. More particularly, the present invention relates to a clinical analysis apparatus to be employed as a μTAS immuno assay system (Micro Total Analysis System, ELISA-Enzyme Linked Immuno-Sorbent Assay system and the like), wherein microchips having reagents and samples introduced into micro flow channels thereof are employed to cause the samples to electrophorese, to analyze separated measurement target substances within the samples.

### BACKGROUND TECHNOLOGY

There is a known microchip electrophoresis apparatus comprising a microchip, in which micro flow channels having extremely small widths and depths are formed (Patent Document 1). In this electrophoresis apparatus, a sample is introduced into the micro flow channels simultaneously with a fluid liquid (buffer liquid), and a high voltage (fluid voltage) is applied to cause electrophoresis to occur, thereby separating a measurement target substance. The separated substance, such as a protein or a nucleic acid, is detected at a detection point within the micro flow channels by a detecting section.

There is another known microchip electrophoresis apparatus (Patent Document 2). This microchip electrophoresis apparatus automatically performs the processes of filling a fluid liquid, introducing a sample, introducing the sample into a separating flow channel, electrophoresis, separation, and detection. In this microchip electrophoresis apparatus, if the same microchip is utilized to perform repeated analysis, samples that remain in the flow channels thereof are washed away, another sample is introduced, and the above steps are executed. In the case that the microchips are disposable, the microchips are discarded without washing the samples that remain in the flow channels thereof.

A microchip electrophoresis apparatus that adjusts the temperatures of microchips and liquids such as reagents and samples to be introduced into the micro flow channels of the microchips to be approximately the same temperature separately, injects the liquids into the microchips, then performs measurement is also known (Patent Document 3).

[Patent Document 1]

### Japanese Unexamined Patent Publication No. 10-148628

[Patent Document 2]

### Japanese Unexamined Patent Publication No. 10-246721

[Patent Document 3]

### Japanese Unexamined Patent Publication No. 2006-250622

### DISCLOSURE OF THE INVENTION

### Problem to be Solved by the Invention

In order to individually adjust the temperatures of the microchips and the liquids to be dispensed into the microchips, such as reagents and samples, separate dedicated temperature controlling apparatuses become necessary for the microchips and the liquids, and there is a possibility that temperature differences will occur between the microchips and the samples. In addition, in order to match the temperature of the microchips and the temperature of the sample liquids, it is necessary to control the temperature controlling apparatuses with high accuracy. This causes problems that temperature control becomes complex, and that the size of the apparatus will become large.

The present invention has been developed in view of the foregoing points. It is an object of the present invention to provide a clinical analysis apparatus which is capable of accurately controlling the temperatures of reagents and samples, without causing the apparatus to become large or complex.

### Means for Solving the Problem

A clinical analysis apparatus of the present invention employs microchips in which micro flow channels are formed, introduces reagents and samples into the micro flow channels, and analyzes measurement target substances contained in the sample, and comprises:

a casing;

a stocking section provided in the casing for stocking the reagents and the samples;

a dispensing mechanism, for dispensing the reagents and samples stocked in the stocking section to the microchips; and

a measuring section, for measuring the measurement target substances within the samples, which have been dispensed into the micro flow channels, the measuring section including a conveyance mechanism, for conveying the microchips at a predetermined pitch; and is wherein:

the measuring section further comprises a dispensing station at which the reagents and samples are dispensed into the microchips, and a detecting station for detecting the measurement target substances, provided in this order from the upstream side of processes to be performed at the predetermined pitch;

the microchips are moved relative to each of the stations at the predetermined pitch from the upstream side toward the downstream side of the processes to be performed; and

a temperature controlling section is provided to enable the temperatures of the microchips, in which the reagents and the samples have been dispensed, to be controlled prior to the microchips being moved to the detecting station.

The predetermined pitch is a pitch that corresponds to movement of the microchips among each of the stations.

Note that the predetermined pitch may be a predetermined angular pitch.

In addition, the microchips refer to those having chip substrates formed of glass or the like, in which fine capillaries are formed. Samples are introduced into the capillaries. The capillaries are referred to as the “micro flow channels”. The reagents include buffer liquids, various types of labeling antibodies, and the like.

The temperature controlling section may be configured to be capable of controlling the temperatures of the microchips, in which the reagents and the samples have been dispensed, from a point in time prior to the microchips being moved to the detecting station to a point in time at which detection of the measurement target substance at the detecting station is completed.

The temperature controlling section may also be configured to be capable of controlling the temperatures of the microchips, in which the reagents and the samples have been dispensed, from a point in time at which the microchips are moved to the dispensing station to a point in time at which detection of the measurement target substance at the detecting station is completed.

The temperature controlling section may be configured to be capable of controlling the temperature of only the microchips prior to the microchips being moved to the dispensing station.

The temperature controlling section may be configured to determine target temperatures that the temperatures of the microchips are to be controlled to, according to the contents of measurements to be performed by the measuring section.

The temperature controlling section may be configured to control the temperatures of the microchips, in which the reagents and the samples have been dispensed, independently at each of the stations.

The temperature controlling section may be configured to control the temperatures of the microchips, in which the reagents and the samples have been dispensed, for all of the stations together.

An introducing station, for introducing the reagents and the samples into the micro flow channels of the microchips by pressurizing or suctioning the reagents and the samples, may be provided between the dispensing station and the detecting station.

Note that the microchips may be disposable microchips.

The clinical analysis apparatus may be configured such that the microchips are moved relative to each of the stations from the upstream side to the downstream side of the processes to be performed unidirectionally and at the predetermined pitch, to perform measurement of the measurement target substance.

The clinical analysis apparatus may alternatively be configured such that the microchips are moved relative to each of the stations from the upstream side to the downstream side of the processes to be performed by rotating movement at the predetermined pitch, to perform measurement of the measurement target substance repeatedly.

In the case that the clinical analysis apparatus is configured to rotate the microchips with respect to the stations to perform measurement of the measurement target substance repeatedly, the following configurations may additionally be adopted.

A microchip attaching/removing station for attaching or removing the microchips may be provided at a desired position.

A cleansing station for cleansing the microchips after the measurement target substance is detected may be provided.

Here, the dispensing station, the detecting station, and the cleansing station may be provided in the measuring section such that they are arranged in this order from the upstream side of processes to be performed at the predetermined pitch.

Further, the cleansing station may perform: a chemical cleansing step; a water cleansing step performed after the chemical cleansing step; and a remaining liquid suction step for suctioning liquids that remain after the water cleansing step. In this case, the chemical cleansing step performs chemical cleansing to wash away the chemicals which are attached on the microchips, the water cleansing step performs further cleansing with water, and the remaining liquid suction step suctions the liquids that remain after the water cleansing step. Therefore, the micro flow channels can be cleansed to a high degree, substantially eliminating influence to subsequent measurement operations. Accordingly, highly reliable analysis results can be obtained. It is preferable for each of the steps performed by the cleansing station to be performed by an independent station.

The conveyance mechanism may comprise a rotating table, on which the microchips are provided.

In the clinical analysis apparatus, it is preferable for the number of stations and the number of microchips mounted on the rotating table to be the same.

It is preferable for the clinical analysis apparatus to be configured such that the series of processes to be performed on a single microchip is completed during a single rotation of the rotating table.

Note that in the clinical analysis apparatus that performs measurement of the measurement target substance by moving the microchips unidirectionally with respect to each of the stations, and in the clinical analysis apparatus that repeatedly performs measurement of the measurement target substance by rotating the microchips with respect to each of the stations, it is preferable for the microchips to be equipped with recording sections, in which data regarding processes performed thereon is recorded. The recording sections may be wireless tags.

### Advantageous Effects of the Invention

The clinical analysis apparatus of the present invention is configured such that the microchips are moved relatively with respect to the stations from the upstream side to the downstream side of the processes to be performed, to repeatedly perform measurement of the measurement target substance. The temperature controlling section is provided such that it is capable of controlling the temperature of the microchips in a state that the reagents and samples are dispensed into the microchips, prior to the microchips being moved to the detecting station. Therefore, the temperatures of the reagents and samples can be more accurately controlled when detecting the measurement target substance at the detecting station, without causing the apparatus to become large or complex.

That is, temperature control can be performed in a state that the reagents and samples (hereinafter, also collectively referred to as “sample liquids”) are dispensed into the microchips. Therefore, matching of the temperatures of the microchips and the sample liquids is facilitated, compared to a conventional case in which the temperatures of the microchips and the sample liquids are controlled separately. In addition, the temperatures of the sample liquids are controlled in a state in which the sample liquids are contained in the microchips. Therefore, the apparatus can be kept from becoming complex, compared to a case in which the temperatures of the microchips and the sample liquids are controlled separately. Further, because temperature control can be initiated from a step prior to the detecting step to be performed at the detecting station, the amount of time that temperature control is exerted in a state in which the sample liquids are dispensed into the microchips can be lengthened. From the above, measurement can be performed with the temperature of the sample liquids being more accurately determined when the measurement target substance is detected at the detecting station, without causing the apparatus to become large or complex.

Note that the temperature controlling section may be configured to be capable of controlling the temperatures of the microchips, in which the reagents and the samples have been dispensed, from a point in time prior to the microchips being moved to the detecting station to a point in time at which detection of the measurement target substance at the detecting station is completed. In this case, the advantageous effect of the temperature of the sample liquids during detection of the measurement target substance at the detecting station being more accurately determined can be exhibited more positively.

Also, the temperature controlling section may be configured to be capable of controlling the temperatures of the microchips, in which the reagents and the samples have been dispensed, from a point in time at which the microchips are moved to the dispensing station to a point in time at which detection of the measurement target substance at the detecting station is completed. In this case, the advantageous effect of the temperature of the sample liquids during detection of the measurement target substance at the detecting station being more accurately determined can be exhibited more positively.

In addition, the temperature controlling section may be configured to determine target temperatures that the temperatures of the microchips are to be controlled to, according to the contents of measurements to be performed by the measuring section. In this case, the temperature of the sample liquids when the measurement target substance is detected at the detecting station can be more quickly adjusted to the target temperature. Therefore, detection of the measurement target substance can be performed more efficiently.

An introducing station, for introducing the reagents and the samples into the micro flow channels of the microchips by pressurizing or suctioning the reagents and the samples, may be provided between the dispensing station and the detecting station. In this case, the reagents and the samples can be sufficiently introduced into the micro flow channels in short periods of time.

A microchip attaching/removing station for attaching or removing the microchips may be provided at a desired position. In this case, the microchips can be easily exchanged, as necessary. In other words, each microchip can be repeatedly used until the end of its lifetime, and then can be easily exchanged for a new microchip.

The cleansing station may perform: a chemical cleansing step; a water cleansing step performed after the chemical cleansing step; and a remaining liquid suction step for suctioning liquids that remain after the water cleansing step. In this case, the chemical cleansing step performs chemical cleansing, the water cleansing step removes the chemicals utilized in the chemical cleansing step, and the remaining liquid suction step suctions the liquids that remain after the water cleansing step. Therefore, the micro flow channels can be cleansed to a high degree, substantially eliminating influence to subsequent measurement operations. Accordingly, highly reliable analysis results can be obtained.

In the case that the clinical analysis apparatus is configured to rotate the microchips with respect to the stations to perform measurement of the measurement target substance repeatedly, the conveyance mechanism can be easily configured.

In the clinical analysis apparatus, the number of stations and the number of microchips mounted on the rotating table may be the same. In this case, operations can be performed on each microchip by each station at every incremental rotation of the rotating table. Therefore, measurements can be performed efficiently.

The clinical analysis apparatus may be configured such that the series of processes to be performed on a single microchip is completed during a single rotation of the rotating table. In this case, measurement of a microchip is completed with each incremental rotation of the rotating table. Therefore, measurements can be performed efficiently within short periods of time.

The microchips may be equipped with recording sections, in which data regarding processes performed thereon is recorded. In this case, each of the microchips can be individually managed, mistakes are unlikely to occur, and highly reliable data can be obtained.

### BEST MODE FOR CARRYING OUT THE INVENTION

Hereinafter, an embodiment of the clinical analysis apparatus of the present invention will be described in detail with reference to the attached drawings. First, a microchip 100 which is utilized in a clinical analysis apparatus 1 (hereinafter, simply referred to as “apparatus 1”; refer to FIG. 3) to detect liver cancer markers, for example, will be described with reference to FIG. 1A, FIG. 1B, and FIG. 2.

FIG. 1A and FIG. 1B illustrate an example of the microchip 100 which is utilized in the apparatus 1, wherein FIG. 1A is a perspective view of the top surface, and FIG. 1B is a perspective view of the bottom surface thereof.

The microchip 100 is molded from synthetic resin into a substantially rectangular shape or an arrowhead shape. A rectangular glass plate 102 (transparent plate member) is mounted in the central portion of a recess 100b of the underside of the microchip 100, as a chip substrate. The glass plate 102 is constituted by joining two glass plates. Micro flow channels 110 (capillaries, hereinafter, simply referred to as “flow channels”; refer to FIG. 2) are formed in one of the two glass plates, and the two glass plates are joined together such that the flow channels 110 are sandwiched therebetween. Both of the glass plates may be transparent, or only the glass plate on the side at which optical measurement to be described later is performed may be transparent.

Meanwhile, a plurality of cylindrical protrusions, that is, wells 106, are formed on the top surface, that is, the main surface 100a of the microchip 100, as illustrated in FIG. 1A. The wells 106 have inner diameters of 1.2 mm, for example, and are formed at positions that correspond to those of the flow channels 110. Holes 106a of the wells 106 penetrate through one of the two glass plates, to communicate with the flow channels 110.

Accordingly, if sample liquids containing reagents and samples are dripped onto the wells 106, the sample liquids are guided into the flow channels 110. Note that the material of the chip substrate is not limited to glass, and may be synthetic resin.

Next, the flow channels 110 will be described with reference to FIG. 2. FIG. 2 is a plan view of a flow channel 110 which is formed in the microchip 100. The flow channel 110 is formed by a fine processing technique such as etching or lithography, and is 100 μm wide and 15 μm deep, for example. Two sets, for example, of independent flow channels 110 are formed in the microchip 100. The flow channel 110 comprises a main flow channel 110a, which extends in the horizontal direction in FIG. 2, and offshoot flow channels 110b through 110e, which extend for short distances perpendicular from the main flow channel 110a. The wells 106 are positioned at both ends of the main flow channel 110a, as well as at the ends of each of the offshoot flow channels 110b through 110e. Note that each of the wells 106 are denoted by letters A through G. The wells A through G are collectively referred to as “wells 106”.

The offshoot channels 110b, 110c, and 110d are formed toward one side (the upper side in FIG. 2) of the main flow channel 110a, in this order from the side of well A with intervals therebetween. The ends of the offshoot channels 100b, 100c, and 100d communicate with wells B, E, and F, respectively.

The offshoot channel 110e is formed on the other side of the main flow channel 110a (the lower side in FIG. 2), between the offshoot channels 110b and 110c. The end of the offshoot channel 110e extends parallel to the main flow channel 110a in a T shape, and the ends of the extension are in communication with wells C and D.

Note that a detecting device 6, equipped with an optical system for detecting samples, is provided in the vicinity of the flow channel 110, as illustrated in FIG. 2. Sample liquids, which are contained in the flow channels, are measured at a predetermined position within the main flow channel 110a. Measurement target substances contained in the samples are processed such that they exhibit stimulated fluorescence when irradiated by light from the exterior. A laser light beam 140 emitted by a laser diode 138 of the detecting device 6 is employed to stimulate fluorescence of the measurement target substances. The laser beam 140 passes through a BPF 142 (band pass filter), is reflected by a dichroic mirror 144, passes through a condensing lens 146, and is irradiated onto the samples. Thereby, the measurement target substances are stimulated and emit fluorescence. The fluorescence passes through the condensing lens 146, the dichroic mirror 144, a BPF 148 (band pass filter), and a condensing lens 150, to be detected by a photodetector 152.

The samples may be various liquids, including bodily fluids such as blood serum and lymphatic fluid, waste such as urine, living body-derived material such as pus, beverages, and stream water. The reagents are not particularly limited, and may be selected according to the measurement target substance within the samples.

Next, the apparatus 1 of the present embodiment will be described with reference to FIG. 3 through FIG. 8. FIG. 3 is a perspective view that illustrates the outward appearance of the apparatus 1. The apparatus 1 comprises: a casing 2, a stocking section 8, provided in the casing 2; a measuring section 10 provided in the vicinity of the stocking section 8; and a dispensing mechanism 12 that moves reciprocally between the stocking section 8 and the measuring section 10. Covers 4 and 5, which are openable and closable with respect to the casing 2, are provided to cover the measuring section 10 and the stocking section 8, respectively. FIG. 3 illustrates a state in which the covers 4 and 5 are open. The covers 4 and 5 are configured such that they cannot be opened during detection of samples and cleansing operations.

The stocking section 8 comprises a circular reagent bay 8a and a sample holding section 8b. The sample holding section 8b comprises an annular member 14 that surrounds the periphery of the reagent bay 8a. Note that the annular member 14 of the reagent bay 8a and the sample holding section 8b are rotatable. However, drive sources such as motors for rotating the annular member 14 of the reagent bay 8a and the sample holding section 8b have been omitted from FIG. 3. The a plurality of cutouts 14a for holding sample containers 3b are formed in the annular member 14 at predetermined intervals. Note that the interior of the stocking section 8 is cooled by a cooling device (not shown).

A display panel 16 constituted by an LCD or the like is provided on the upper surface 2a of the casing 2. The display panel 16 displays the names of tests, and enables selection of the contents of measurement (items to be measured) for each sample contained in the sample containers 3b. A printer 18 for printing out analysis results obtained by a detecting station 46 is provided in the vicinity of the display panel 16. A parallelepiped cleansing water container 20 and a parallelepiped waste liquid container 22 are mounted on the exterior of the casing 2 in the vicinity of the stocking section 8. The cleansing water container 20 contains water for cleansing the microchips 100 and the like. The waste liquid container 22 contains all waste liquids.

The dispensing mechanism 12 comprises: a moving body 12a; and a probe 12b, which is attached to the moving body 12a. In the present embodiment, a single probe 12b is utilized. Because the probe 12b suctions and conveys samples and a plurality of types of reagents, it is cleansed every time that a different liquid is to be conveyed. The cleansing operation of the probe 12b is performed at a probe cleansing section 66, which is positioned between the measuring section 10 and the stocking section 8. That is, the probe 12b is inserted into an opening 66a of the probe cleansing section 66, and is cleansed by cleansing liquid (not shown) within the cleansing section 66.

Next, the measuring section 10 will be described with combined reference to FIG. 3 and FIG. 4 through FIG. 7. FIG. 4 is a magnified perspective view of the measuring section 10, in which microchips 100′ are provided. Note that the microchips 100′ employed here are different from the microchips 100 in shape, but are the same in principle. Each part of the microchips 100′ will be denoted by a reference number for the corresponding part in the microchips 100 with an “′” attached. FIG. 5 is a schematic plan view that illustrates the stocking section 8 and the measuring section 10 as the main parts of the apparatus 1.

FIG. 6 is a perspective view that illustrates a state in which a microchip 100′ having a reagent and a sample dispensed therein is placed on a temperature controlling section 201 prior to being moved to the detecting station. The microchip 100′ has a glass plate 102′ (refer to FIG. 2 and FIG. 6) that corresponds to the glass plate 102 of the microchip 100 (refer to FIG. 1B). The microchip 100′ is placed on the temperature controlling section 201 such that the glass plate 102′ contacts the temperature controlling section 201. FIG. 7 is a perspective view that illustrates a state in which the microchip 100′ has been removed from the temperature controlling section 201, to show the upper portion of the temperature control section 201.

The measuring section 10 is equipped with: a drive source (not shown) that functions as a conveyance mechanism for conveying the microchips 100′; and a rotating table 40 which is driven to rotate counterclockwise by the drive source. The rotating direction of the rotating 40 is unidirectional in the counterclockwise direction, and the drive source is not configured to enable clockwise rotation.

Eight base portions 200 are provided on the rotating table 40 at a predetermined pitch. The temperature controlling section 201 is provided on each of the base portions 200. If the rotating table 40 is viewed from above, eight recesses 42a are formed at the predetermined pitch (angular pitch), as illustrated in FIG. 4. The base portions 200 and the temperature controlling sections 201 are housed within these recesses 42a. Accordingly, when the microchips 100′ are placed within the recesses 42a, the microchips 100′ come into contact with the upper surfaces 201U of the temperature controlling sections 201 that correspond to the recesses 42a.

Eight stations 42 through 56 are provided on the side of the casing 2 at the same predetermined pitch. Accordingly, the apparatus 1 is configured such that a single microchip 100′ is placed at each of the stations 42 through 56.

The first station, at which the measurement operation is initiated, is a dispensing station 42, at which samples and the like are dispensed into the microchips 100′ by the probe 12b of the dispensing mechanism 12. That is, the dispensing station 42 is where the first step in the measurement operation is performed.

The remaining stations, that is, an introducing station 44; the detecting station 46; cleansing stations 47; and a microchip attaching/removing station 56, for attaching and removing the microchips 100′, are provided on the rotating table 40 in this order in the counterclockwise direction. Note that in the present embodiment, the cleansing stations 47 comprise four stations, that is, a chemical cleansing station 48, water cleansing stations 50 and 52, and a residual liquid suctioning station 54. The four cleansing stations 48, 50, 52, and 54 perform a chemical cleansing step, a first water cleansing step, a second water cleansing step, and a residual liquid suctioning step, respectively. Note that the UI section (User Interface Section) denoted by reference numeral 13 in FIG. 5 is a so-called operating panel.

Next, each of the stations 42, 44, 46, 47 (48, 50, 52, and 54), and 56 will be described in detail with reference to FIG. 4.

Cover members 44b, 46b, and 52b are mounted on the casing 2 such that they are capable of approaching or separating from the rotating table 40, to perform opening and closing operations. Accordingly, only the rotating table 40 rotates, and the cover members 44b, 46b, and 52b do not move within a plane parallel to the rotating table 40.

The eight stations 42 through 56 are provided about the circumference of the rotating table 40 such that they are equidistant from each other. The amount of time spent performing operations at each of the eight stations 42 through 56 is the same, for example, 200 seconds. That is, after 200 seconds pass, the rotating table 40 rotates to the next step. Therefore, one cycle is completed after a single rotation (200×8=1600 seconds), and measurement operations for the first microchip 100′ are completed. Thereafter, the measurement operations for the remaining microchips 100′ are sequentially completed after 200 second intervals.

When a microchip 100′ are placed at a position corresponding to the dispensing station 42, the moving body 12a of the dispensing mechanism 12 moves to the dispensing station 42, and samples or reagents are dripped into a predetermined well 106′ by the probe 12b. This operation is repeated for all of the wells 106′ at which reagents or samples are necessary (first step).

A cover member 44b is provided so as to be openable and closable at the introducing station 44. Tubes 44c for communicating with predetermined wells 106′ of the microchip 100′ are mounted on the cover member 44b. Pressurized gas is supplied into the wells C and D illustrated in FIG. 2 via the tubes 44c (second step).

A cover member 46b is mounted at the detecting station 46. Electrodes (not shown) for applying voltages used in electrophoresis are provided on the underside of the cover member 46b. The electrodes are positioned to correspond to the wells A, F, and G, through which the voltages are applied.

A light measuring section 58 of the detecting station 46 has the aforementioned detecting device 6 (refer to FIG. 2) incorporated therein. The light measuring section 58 is configured to be positioned above the cover member 46b during detection, and to retreat to a position toward the exterior of the rotating table 40 when the cover member 46b is opened, to avoid interfering therewith. The voltages are applied by the electrodes to cause samples to electrophorese at the detecting station 46 (third step). At this time, stable electrophoresis of the samples can be realized at a low temperature, for example, 10° C., depending on the sample.

Next, the wells 106′ to which voltages are applied to are switched (fourth step). Electrophoreses is maintained, and measurement of the measurement target substance is performed (fifth step).

During this measurement, dripping of reagents and the like into each flow channel 110′ can be performed with time lags therebetween, because two sets of flow channels 110′ are provided. Therefore, the times that the samples reach the measurement positions within the flow channels 110′ can be shifted, and sequential measurements can be performed.

The two flow channels 110′ are slightly shifted with respect to each other within the plane of the glass plate 102′. Accordingly, the lens of the optical system can move slightly after measurement of a first flow channel 110′ to measure a second flow channel 110′.

Here, the temperature control exerted by the temperature controlling sections 201 will be described.

Peltier elements, for example, may be applied as the temperature control sections 201 which are provided on the base portions 200. The upper surfaces 201U of the temperature controlling sections 201 contact the glass plates 102′, in which the flow channels are formed, to support the microchips 100′ from below.

As described above, a microchip 100′ is placed on the rotating table 40 at each of the positions corresponding to the stations 42 through 56. That is, a base portions 200 and a temperature controlling section 201 is provided at each of the positions corresponding to the eight stations 42 through 56, and each of the temperature controlling sections supports a microchip 100′, which are conveyed in a rotating manner.

The temperature controlling sections 201 are configured to be capable of controlling the temperatures of the microchips 100′, into which the sample liquids containing reagents and samples have been dispensed, prior to the microchips 100′ being conveyed to the detecting station 46.

The temperature controlling sections 201 may be configured to control the temperatures of the microchips 100′, into which the sample liquids have been dispensed, from a point in time prior to the microchips 100′ being moved to the detecting station 46 to a point in time at which detection of the measurement target substance at the detecting station 46 is completed.

Alternatively, the temperature controlling section 201 may be configured to be capable of controlling the temperatures of the microchips 100′ from a point in time at which the sample liquids are dispensed into the microchips 100′ at the dispensing station 42, that is, from a point in time at which the microchips are conveyed to the dispensing station 42, to a point in time at which detection of the measurement target substance at the detecting station 46 is completed.

The temperature controlling sections 201 may be configured to determine target temperatures that the temperatures of the microchips 100′ are to be controlled to, according to the contents of measurements (items to be measured) to be performed by the measuring section 10.

Further, the temperature controlling section 201 may be configured to control the temperatures of the microchips 100′, in which the sample liquids have been dispensed, independently at each of the stations. More specifically, the temperatures of the microchips 100′, which are conveyed to each of the eight stations 42, 44, 46, 48, 50, 52, 54, and 56, may be controlled to be a target temperature, which is set to be a different temperature at each of the stations.

Note that the temperature controlling sections 201 are not limited to those that perform temperature control by causing a Peltier element to contact the glass plate, in which the flow channels are formed. Any temperature controlling method may be employed to control the temperatures of the microchips, in which the sample liquids have been dispenced.

Next, the cleansing stations 47 will be described in detail. The cleansing stations 47 comprise the four stations 48, 50, 52, and 54, each of which performs a single cleansing step. The chemical cleansing station 48 employs a chemical (cleansing agent) such as NaOH (sodium hydroxide) to cleanse the flow channels 110′ of used microchips 100′. The chemical cleansing station 48 is configured to cleanse wells 106′ contaminated by samples, by discharging the chemical into the wells 106′ and then suctioning it out. At this time, the chemical is suctioned from the flow channels 110′ at a negative pressure of for example, 300 g/cm².

The chemical cleansing step is performed as illustrated in FIG. 8, for example. FIG. 8 is a magnified perspective view that illustrates the, main parts of the chemical cleansing station 48. The two flow channels 110′ are formed in each microchip 100′. Probes 48p and 48q are configured to discharge and suction chemicals to each of the two flow channels 110′. The probes 48p and 48q are capable of moving in the directions indicated by arrow 60. This movement is performed employing a motor 48c illustrated in FIG. 4, and a threaded shaft 48d, which is driven by the motor 48c. That is, a member 48e that supports the microchip 100′ is engaged with the threaded shaft 48d, and the microchip 100′ is moved reciprocally in the radial direction of the rotating table 40 by rotation of the threaded shaft 48d.

Note that only the tips of the probes 48p and 48q are illustrated in FIG. 8. However, the probes 48p and 48q extend as illustrated by the broken lines, or have tubes attached thereto. A chemical (cleansing agent) container 15 and a probe cleansing tank 17 are also provided in the chemical cleansing station 48. The cleansing agent is contained in the chemical container 15. The cleansing agent is supplied to the wells 106′ by the probes 48p and 48q.

During the chemical cleansing operation, the tips of the probes 48p and 48q are inserted into the wells 106′ of the microchips 100′, and therefore they are cleansed within the probe cleansing tank 17 after each insertion. Openings 65a that communicate with a syringe pump (not shown) are formed in a sealing plate 65 at positions that correspond to the wells 106′. Pressure supplied by the syringe pump is utilized to expel the chemical from the wells 106′ and the micro flow channels 110′.

The chemical is discharged into the plurality of wells 106′ aligned in a single row by the probe 48p, and suctioned out from the wells 106′ aligned in another row at the aforementioned negative pressure of 300 g/cm². The manner of cleansing will be described with combined reference to FIG. 9. FIG. 9 is a magnified sectional view that illustrates the concept of cleansing of a well 106′ and the application of negative pressure on another well 106′. FIG. 9 illustrates a state in which the probe 48p is inserted into a well 106′, while discharging and suctioning a chemical 62 such that it does not overflow from the well 106′. FIG. 9 also illustrates a state in which another well 106′ is sealed by sealing members 64 and the sealing plate 65, which were not illustrated in FIG. 4, while negative pressure is applied to perform suction. In this manner, the samples and chemical 62 are suctioned from the wells 106′ and the flow channels 110′ while the probes 48p and 48q move. Thereby, the flow channels 110′ are sufficiently cleansed. Accordingly, the degree of cleansing is high. Note that the portion denoted by reference number 102′ in FIG. 9 is the glass plate 102′.

After the chemical cleansing step, the water cleansing station 50 performs discharge and suction of water to all of the wells 106′ in the same manner as that illustrated in FIG. 7. Further, the water cleansing station 52 expels the chemical from the flow paths 110′ with a water pressure of, for example, 10 kg/cm². At this time, the well 106′ through which the water and the chemical are expelled is open to the atmosphere, and the expelled waste liquid is contained in the waste liquid container 22. Next, the residual liquids remaining in the wells 106′ are suctioned out by the residual liquid suctioning station 54. This operation is performed by a probe 54p (refer to FIG. 4), which is connected to a negative pressure source, being inserted into the wells 106′.

Next, the cleansed microchips 100′ are conveyed to the microchip attaching/removing station 56. If a microchip 100′ has been used a predetermined number of times, which is considered to be its usable lifetime, for example, 10 to 200 times, the microchip attaching/removing station 56 removes the microchip 100′ and mounts a new microchip 100′ on the rotating table 40. The microchip attaching/removing station 56 only functions when exchanging microchips 100′, and does not operate during normal measurement.

FIG. 10A and FIG. 10B are partial magnified perspective views that illustrate states in which a microchip 100′ is being exchanged by the microchip attaching/removing station 56. An opening 56c corresponding to a recess 56a of the rotating table 40 is provided, for example, in the casing 2, at the microchip attaching/removing station 56. The opening 56c may be open at all times, or an appropriate lid (not shown) may be provided to open and close the opening 56c.

A microchip 100′ at the end of its useful lifetime can be accessed through the opening 56c and removed, and a new microchip 100′ may be loaded through the opening 56c. In order to judge whether a microchip 100′ has reached the end of its useful lifetime, a wireless tag 101′ (recording portion) may be provided on the microchip 100′. The number of times that the microchip 100′ has been used may be automatically be recorded in the wireless tag 101′, and when a predetermined number is reached, a message prompting exchange of the microchip 100′ may be displayed on the display panel 16. Alternatively, an operator may be notified of the need to exchange microchips 100′ by an audio signal. The counting of the number of uses and recording of the number of uses into the wireless tag 101′ may be managed by a control section 11 (refer to FIG. 5), provided on the rear side of the apparatus 1, for example. Note that the wireless tag 101′ may be provided at a desired position on the microchip 100′ by fitting, embedding, or any other means.

As described above, the apparatus 1 of the present embodiment is capable of efficiently performing accurate measurements, and is therefore suited for clinical use. In addition, a plurality of flow channels 110 and 110′ are formed in the microchips 100 and 100′. Therefore, a single microchip may be utilized to measure the same items to be analyzed for a plurality of patients, or to measure a plurality of items to be analyzed for a single patient. The number of flow channels 110 and 110′ may be increased further, to enable measurement of a plurality of items to be analyzed for a plurality of patients.

Note that in the present embodiment, the microchips 100 and 100′ are rotated through the stations. Alternatively, the stations may be rotated to perform their respective processes on the microchips. In addition, the cleansing stations 47 comprise the plurality of cleansing stations that perform different cleansing steps. Alternatively, the plurality of cleansing steps may be performed by a single cleansing station. Further, in the above embodiment, the reagents and samples are introduced into the wells by being pressurized. Alternatively, the reagents and samples may be introduced into the wells by suctioning from an opposing well. The pressurization and suction may be performed independently, or simultaneously.

In the present embodiment, the reagents and samples are caused to electrophorese within the micro flow channels 110 and 110′. However, the present invention is not limited to this embodiment. Movement and separation within the micro flow paths 110 and 110′ may be performed by pressurization and/or suction.

The temperature controlling sections may be configured to control the temperatures of only the microchips prior to the microchips being conveyed to the dispensing station.

The temperature controlling sections may be configured to control the temperatures of the microchips, in which the reagents and the samples have been dispensed, for all of the stations together.

FIG. 11 is a diagram that illustrates a clinical analysis apparatus 2 according to an embodiment different from the apparatus 1.

The apparatus 1 described previously is configured to continuously rotate the microchips relative to each of the stations at the predetermined pitch, to repeatedly perform measurement of the measurement target substances.

In contrast, the clinical analysis apparatus 2 (hereinafter, simply referred to as “apparatus 2”) moves the microchips relative to each of the stations from the upstream side to the downstream side of the processes to be performed unidirectionally and at the predetermined pitch, to perform measurement of the measurement target substance.

More specifically, the apparatus 2 is the apparatus 1, from which the cleansing stations 47 and the microchip attaching/removing station 56 are removed, to which a chip supplying station 72 is added upstream of the dispensing station 42, and to which a chip discarding station 74 is added downstream of the detecting station 46.

In the apparatus 2, microchips which are utilized for clinical analysis are discarded after measurement. That is, the apparatus 2 performs clinical analysis employing disposable microchips 100″.

In addition, the apparatus 2 is provided with a unidirectionally moving table 40′, as a conveyance mechanism for unidirectionally moving the disposable microchips 100″. The unidirectional movement of the disposable microchips 100″ is from the upstream side to the downstream side.

The unidirectionally moving table 40′ moves the disposable microchips 100″ from the dispensing station 42 to the detecting station 46 unidirectionally at a predetermined pitch.

In this manner, the apparatus 2 is similar in construction to the apparatus 1. Therefore, elements which are the same as those of the apparatus 1 will be denoted with the same reference numerals, and detailed descriptions thereof will be omitted.

Hereinafter, the apparatus 2, which is a clinical analysis apparatus, will be described.

A great number of disposable microchips 100″ are stored in the chip supplying station 72, which is provided toward the downstream side of the dispensing station 42. The chip supplying station supplies the disposable microchips 100″ stored therein to the dispensing station 42 according to commands issued by the control section 11.

The chip discarding station 74, which is provided after the detecting station 46, discards the disposable microchips 100″, for which detection at the detecting station 46 has been completed. The chip discarding station 74 removes the disposable microchips 100″, for which detection has been completed, from the detecting station 46 and discards them, according to commands issued by the control section 11.

A temperature controlling section 76a, which constitutes a portion of the temperature controlling section that the apparatus 2 is equipped with, is configured to be capable of controlling the temperatures of only the disposable microchips 100″ before the disposable microchips 100″ are conveyed to the dispensing station 42. That is, the temperature controlling section 76a is configured to be capable of controlling the temperatures of the disposable microchips 100″ which are stored within the chip supplying station 72.

A temperature controlling section 76b which is also provided in the apparatus 2 controls the temperatures of the disposable microchips 100″, in which the reagents and samples have been dispensed, collectively at a plurality of stations, here, the dispensing station 42, the introducing station 44, and the detecting station 46. Note that the temperature controlling section 76b may alternatively control the temperatures of the disposable microchips 100″, in which the reagents and samples have been dispensed, individually at the dispensing station 42, the introducing station 44, and the detecting station 46, respectively.

The other components of the apparatus 2 are the same as those of the apparatus 1.

In the apparatus 2, the temperature controlling section 76a and the temperature controlling section 76b are driven in advance. The disposable microchips 100″ are supplied from the chip supplying station 72 to the dispensing station 42. Thereafter, the disposable microchips 100″ are moved sequentially to the introducing station 44 and the detecting station 46. Detection is performed at the detecting station 46. Then, the chip discarding station 74 removes and discards the microchips. 100″, for which detection at the detecting station 46 has been completed.

Note that the operations of the dispensing station 42, the introducing station 44, the detecting station 46, the dispensing mechanism 12, the UI section 13, the control section 11, the stocking section 8, and the like of the apparatus 2 are the same as the operations of the dispensing station 42, the introducing station 44, the detecting station 46, the dispensing mechanism 12, the UI section 13, the control section 11, the stocking section 8, and the like of the apparatus 1.

### BRIEF DESCRIPTION OF THE DRAWINGS

FIG. 1A a perspective view of the top surface of a microchip which is utilized in a clinical analysis apparatus of the present invention

FIG. 1B a perspective view of the bottom surface of the microchip which is utilized in the clinical analysis apparatus of the present invention

FIG. 2 a plan view of a micro flow channel which is formed in the microchip of FIG. 1A and FIG. 1B

FIG. 3 a perspective view of the clinical analysis apparatus of the present invention

FIG. 4 a magnified perspective view of a measuring section of the clinical analysis apparatus of FIG. 3, in which microchips are provided

FIG. 5 a schematic plan view that illustrates a stocking section and the measuring section as the main parts of the clinical analysis apparatus

FIG. 6 a perspective view that illustrates a state in which a microchip having a reagent and a sample dispensed therein is placed on a temperature controlling section

FIG. 7 a perspective view that illustrates a state in which the microchip illustrated in FIG. 6 has been removed, to show the upper portion of the temperature control section

FIG. 8 a magnified perspective view that illustrates the main parts of a chemical cleansing station of the clinical analysis apparatus of FIG. 3

FIG. 9 a magnified sectional view that illustrates the concept of cleansing of a well and the application of negative pressure on another well

FIG. 10A a partial magnified perspective view that illustrate a states in which a microchip is being exchanged by a microchip attaching/removing station of the clinical analysis apparatus of FIG. 3.

FIG. 10B a partial magnified perspective view that illustrate a states in which a microchip is being exchanged by a microchip attaching/removing station of the clinical analysis apparatus of FIG. 3.

FIG. 11 a diagram that illustrates a clinical analysis apparatus according to an alternate embodiment

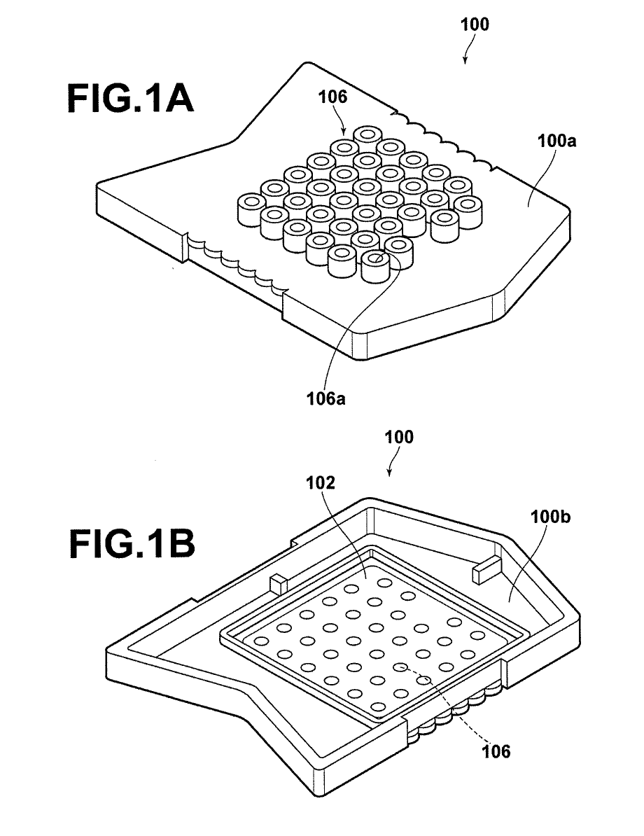

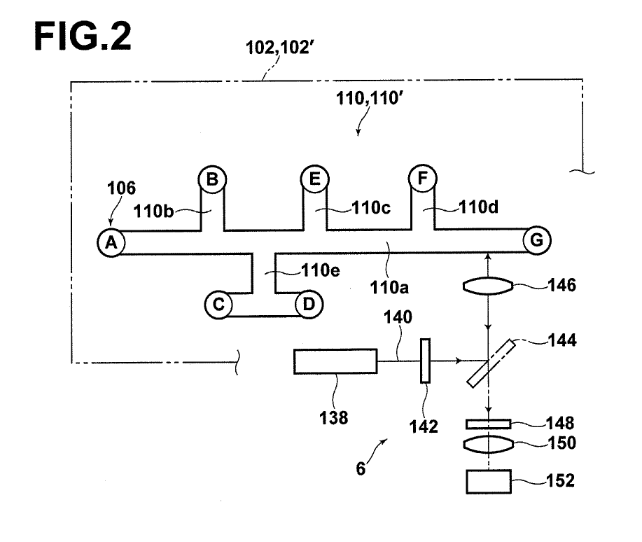

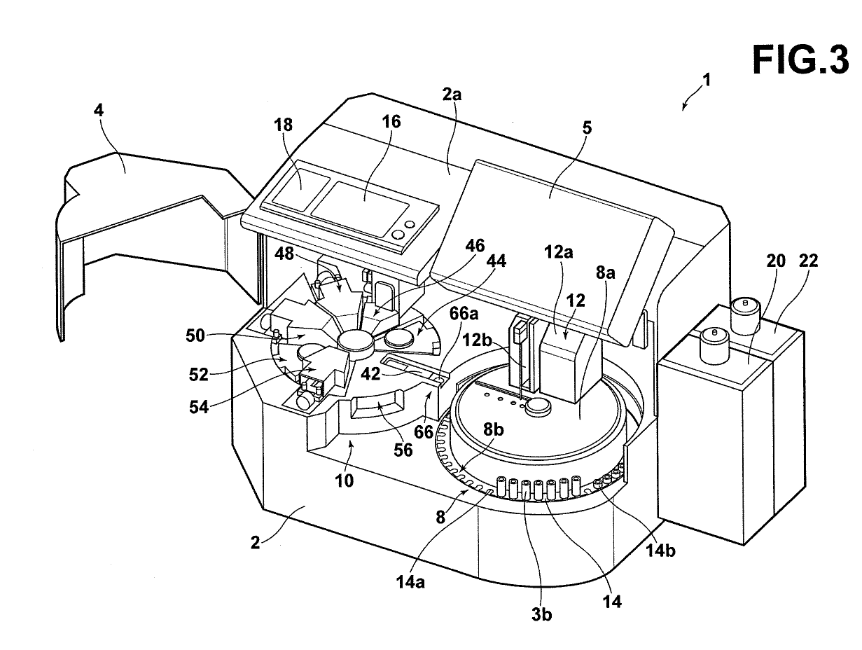

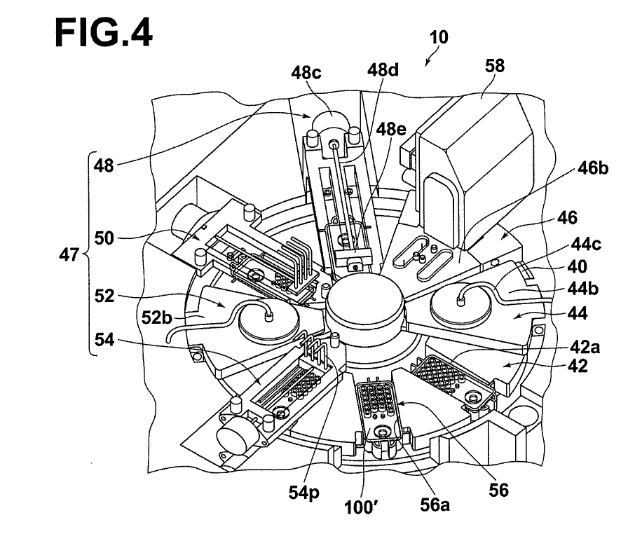

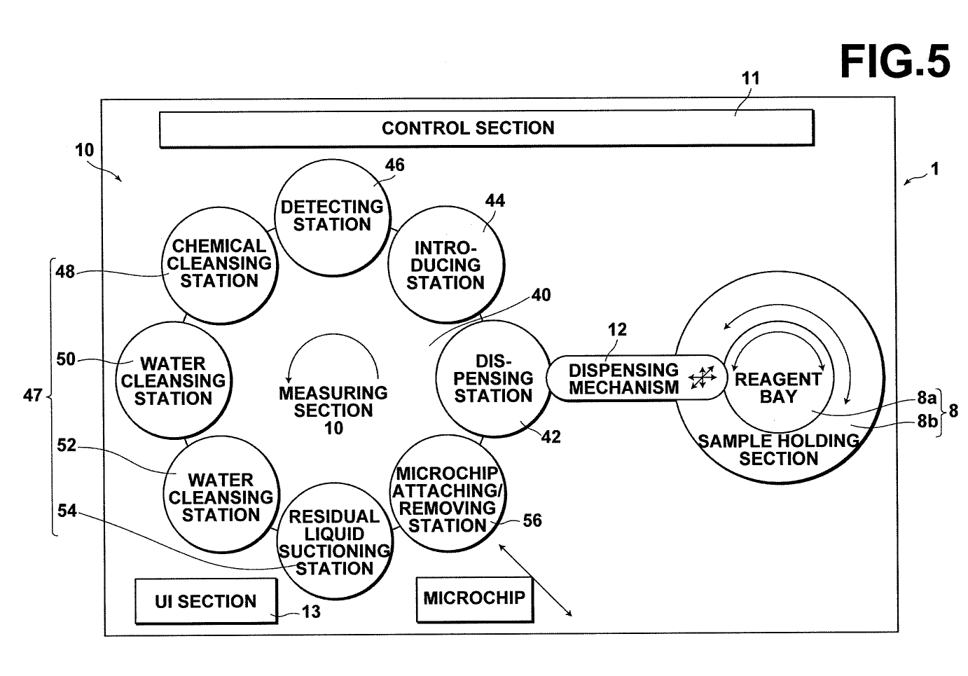

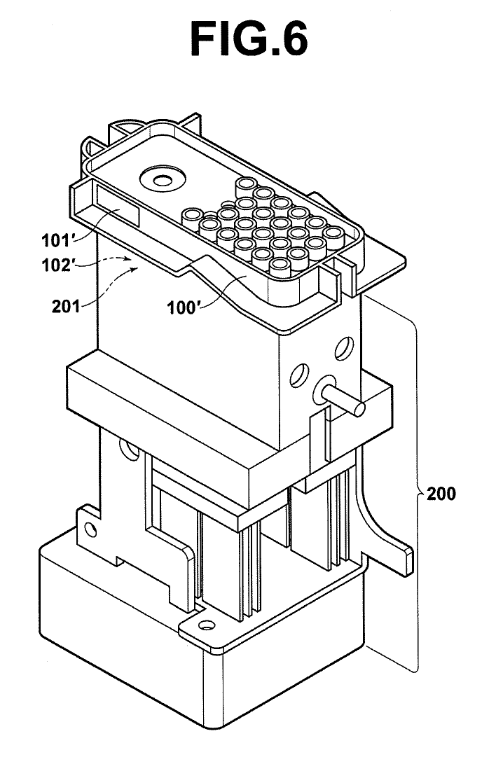

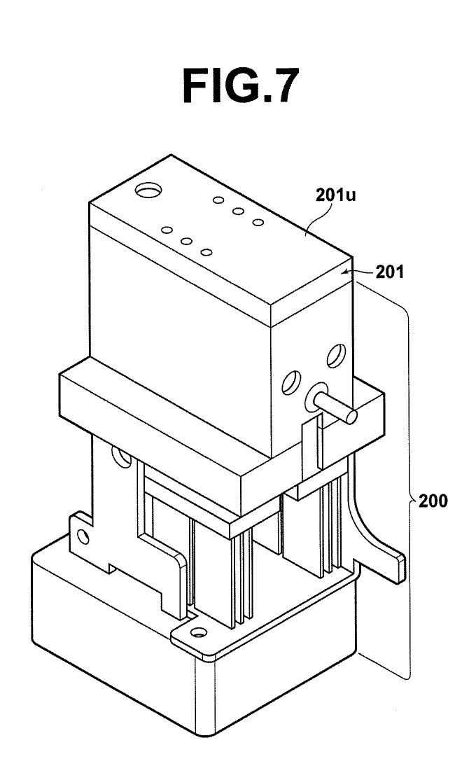

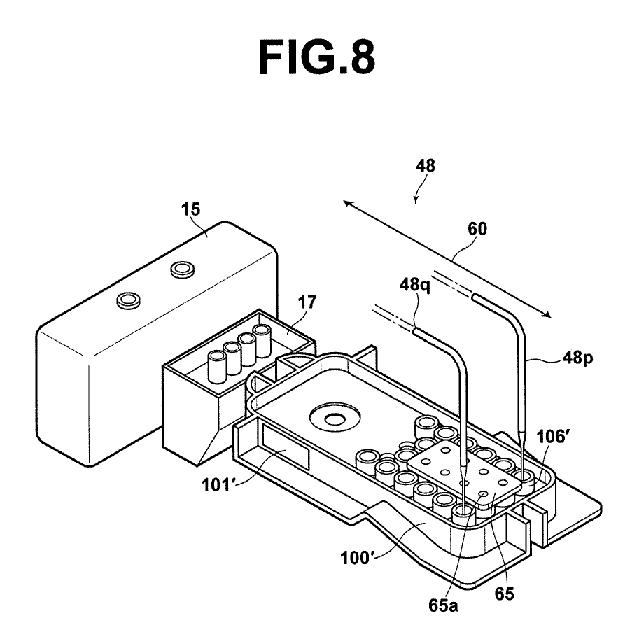

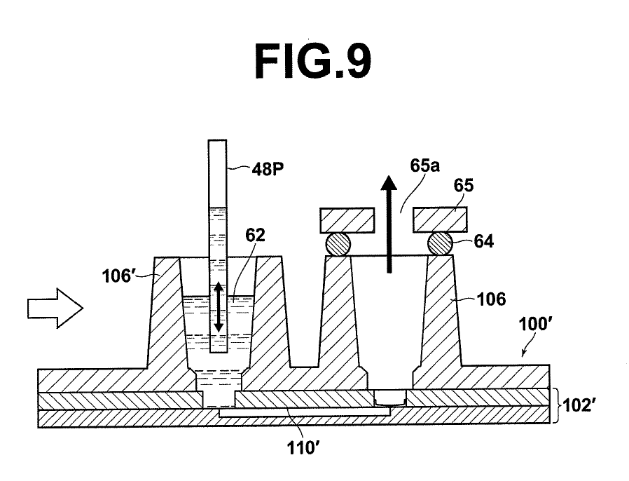

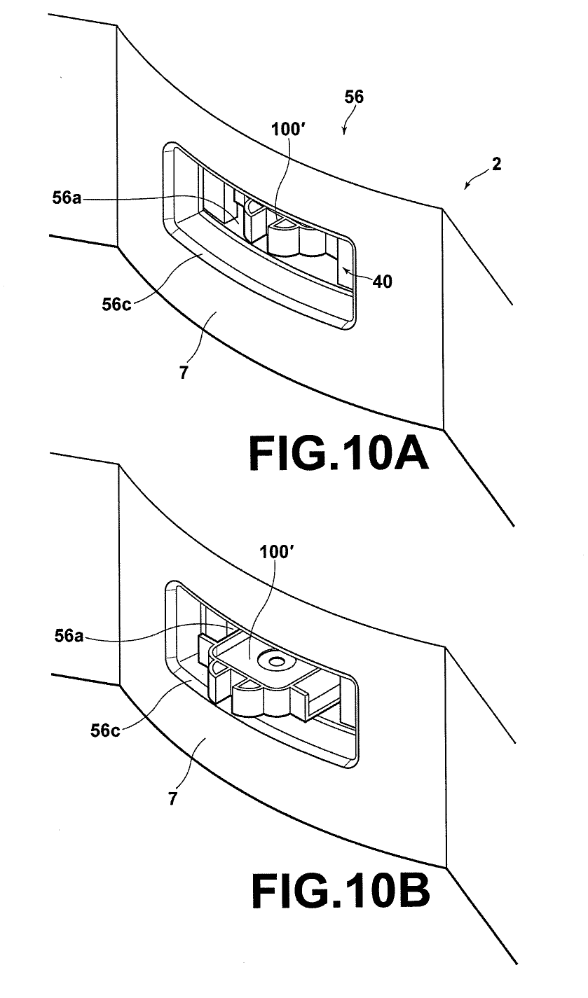

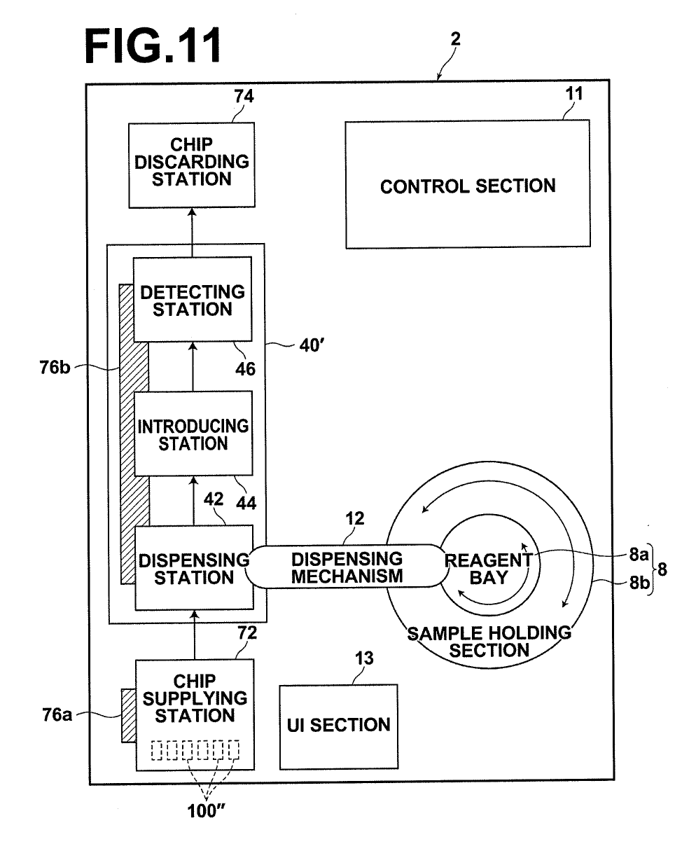

1. A clinical analysis apparatus that employs microchips in which micro flow channels are formed, introduces reagents and samples into the micro flow channels, and analyzes measurement target substances contained in the sample, comprising:
a casing;
a stocking section provided in the casing for stocking the reagents and the samples;
a dispensing mechanism, for dispensing the reagents and samples stocked in the stocking section to the microchips; and
a measuring section, for measuring the measurement target substances within the samples, which have been dispensed into the micro flow channels, the measuring section including a conveyance mechanism, for conveying the microchips at a predetermined pitch; wherein:
the measuring section further comprises a dispensing station at which the reagents and samples are dispensed into the microchips, and a detecting station for detecting the measurement target substances, provided in this order from the upstream side of processes to be performed at the predetermined pitch;
the microchips are moved relative to each of the stations at the predetermined pitch from the upstream side toward the downstream side of the processes to be performed; and
a temperature controlling section is provided to enable the temperatures of the microchips, in which the reagents and the samples have been dispensed, to be controlled prior to the microchips being moved to the detecting station.

2. A clinical analysis apparatus as defined in claim 1, wherein:
the temperature controlling section is configured to be capable of controlling the temperatures of the microchips, in which the reagents and the samples have been dispensed, from a point in time prior to the microchips being moved to the detecting station to a point in time at which detection of the measurement target substance at the detecting station is completed.

3. A clinical analysis apparatus as defined in claim 1, wherein:
the temperature controlling section is configured to be capable of controlling the temperatures of the microchips, in which the reagents and the samples have been dispensed, from a point in time at which the microchips are moved to the dispensing station to a point in time at which detection of the measurement target substance at the detecting station is completed.

4. A clinical analysis apparatus as defined in claim 1, wherein:
the temperature controlling section is configured to be capable of controlling the temperature of the microchips prior to the microchips being moved to the dispensing station.

5. A clinical analysis apparatus as defined in claim 1, wherein:
the temperature controlling section is configured to determine target temperatures that the temperatures of the microchips are to be controlled to, according to the contents of measurements to be performed by the measuring section.

6. A clinical analysis apparatus as defined in claim 1, wherein:
the temperature controlling section is configured to control the temperatures of the microchips, in which the reagents and the samples have been dispensed, independently at each of the stations.

7. A clinical analysis apparatus as defined in claim 1, wherein:
the temperature controlling section is configured to control the temperatures of the microchips, in which the reagents and the samples have been dispensed, for all of the stations together.

8. A clinical analysis apparatus as defined in claim 1, further comprising:
an introducing station, for introducing the reagents and the samples into the micro flow channels of the microchips by pressurizing or suctioning the reagents and the samples, provided between the dispensing station and the detecting station.

9. A clinical analysis apparatus as defined in claim 3, further comprising:
an introducing station, for introducing the reagents and the samples into the micro flow channels of the microchips by pressurizing or suctioning the reagents and the samples, provided between the dispensing station and the detecting station.

10. A clinical analysis apparatus as defined in claim 1, wherein:
the microchips are moved relative to each of the stations from the upstream side to the downstream side of the processes to be performed unidirectionally and at the predetermined pitch, to perform measurement of the measurement target substance.

11. A clinical analysis apparatus as defined in claim 1, wherein:
the microchips are moved relative to each of the stations from the upstream side to the downstream side of the processes to be performed by rotating movement at the predetermined pitch, to perform measurement of the measurement target substance repeatedly.

12. A clinical analysis apparatus as defined in claim 2, wherein:
the microchips are moved relative to each of the stations from the upstream side to the downstream side of the processes to be performed by rotating movement at the predetermined pitch, to perform measurement of the measurement target substance repeatedly.

13. A clinical analysis apparatus as defined in claim 3, wherein:
the microchips are moved relative to each of the stations from the upstream side to the downstream side of the processes to be performed by rotating movement at the predetermined pitch, to perform measurement of the measurement target substance repeatedly.

14. A clinical analysis apparatus as defined in claim 11, further comprising:
a microchip attaching/removing station for attaching or removing the microchips, provided at a desired position.

15. A clinical analysis apparatus as defined in claim 11, wherein:
the conveyance mechanism is equipped with a rotating table on which the microchips are placed.

16. A clinical analysis apparatus as defined in claim 15, wherein:
the number of the stations is the same as the number of the microchips which are placed on the rotating table.

17. A clinical analysis apparatus as defined in claim 15, wherein:
the series of processes to be performed on a single microchip is completed during a single rotation of the rotating table.

18. A clinical analysis apparatus as defined in claim 1, wherein:
the microchips are equipped with recording sections, in which information regarding the processes administered thereon is recorded.

19. A clinical analysis apparatus as defined in claim 10, wherein:
the microchips are equipped with recording sections, in which information regarding the processes administered thereon is recorded.

20. A clinical analysis apparatus as defined in claim 11, wherein:
the microchips are equipped with recording sections, in which information regarding the processes administered thereon is recorded.
